(19) United States
(12) Patent Application Publication
(10) Pub. No.: US 2023/0097537 A1
(43) Pub. Date: Mar. 30, 2023

(54) A SEQUENTIAL REACTOR FOR ADSORPTION OF POLLUTANTS ONTO ACTIVATED CARBON AND ELECTROCHEMICAL REGENERATION OF THE ACTIVATE

(71) Applicant: National University of Singapore, Singapore (SG)

(72) Inventors: Olivier Lefebvre, N/A (FR); Orlando Garcia Rodriguez, N/A (MX); Hugo Olvera Vargas, N/A (MX); Zuxin Wang, N/A (CN)

(73) Assignee: National University of Singapore, Singapore (SG)

(21) Appl. No.: 17/760,385

(22) PCT Filed: Feb. 22, 2021
(86) PCT No.: PCT/SG2021/050084

§ 371 Date: Aug. 9, 2022

(30) Foreign Application Priority Data
Feb. 20, 2020 (SG) 10202001530U

(51) Int. Cl. C02F 1/467; C02F 1/28; C02F 1/461; B01J 20/20; B01J 20/28; B01J 20/34

(52) U.S. Cl. CPC C02F 1/4672; C02F 1/283; C02F 1/46109; B01J 20/20; B01J 20/28016; B01J 20/28052; B01J 20/2805; B01J 20/3441; B01J 20/3416; C02F 2303/16; C02F 2101/345

(57) ABSTRACT

Disclosed herein is a wastewater treatment reactor that makes use of activated carbon as the adsorbent. The wastewater treatment reaction is suitable for use in an electrochemical advanced oxidation process and includes a cathode and anode, where the cathode is arranged to incorporate activate carbon and carbon brushes. Also disclosed herein are methods making use of the reactor for adsorption of contaminants and its regeneration.

### FIELD OF INVENTION

The current invention relates to a reactor suitable for use to adsorb pollutants from a wastewater onto an activated carbon bed and subsequent regeneration of the activated carbon by electrochemical means. Also disclosed is a method of using the reactor.

### BACKGROUND

The listing or discussion of a prior-published document in this specification should not necessarily be taken as an acknowledgement that the document is part of the state of the art or is common general knowledge.

Industrial contamination of fresh water supplies is a growing problem with serious environmental consequences in both developed and developing countries. Indeed, the toxic and recalcitrant nature of industrial pollutants renders conventional biological wastewater treatment methods challenging. Adsorption onto activated carbon (AC) has proven well-suited for the removal of non-biodegradable compounds from industrial wastewaters and is a simple, effective and inexpensive process. However, adsorption onto AC still suffers from being strictly a separation technology with no catalytic degradation activity towards the adsorbed recalcitrant compounds. Furthermore, the disposal of the exhausted material is expensive and presents a threat to the environment with risks of leaching. Thus, there is a need for AC to be regenerated upon saturation.

Current AC regeneration technologies like chemical, thermal and microbiological processes are limited by factors such as high energy requirement and cost, limited number of regeneration cycles, porosity, deterioration of AC, weight loss in AC, etc. Electrochemical regeneration methods appear promising to overcome these limitations because they can be carried out in situ under ambient conditions of pressure and temperature and do not cause apparent detrimental modification in the structure or mass loss of the AC, allowing its reuse after multiple cycles of adsorption and regeneration (Bañuelos, J. A. et al. J. Appl. Electrochem. 2015, 45, 523-531).

Most electrochemical regeneration approaches are based on the electro-desorption of the pollutant from the AC promoted by local changes in pH (Zanella, O. et al., Environ. Technol. 2016, 38, 549-557; Karabacakoğlu, B. et al., Ind. Eng. Chem. Res. 2014, 53, 13171-13179; and Hou, P. et al., Carbon 2014, 79, 46-57). However, the degradation of the accumulated contaminants poses a challenge. To overcome this issue, a few studies have proposed in situ electrochemical AC regeneration by the hydroxyl radical (.OH)—a strong and non-selective oxidant—generated either by electro-peroxone (Zhan, J. et al., Carbon 2016, 109, 321-330) or electro-Fenton (EF) (Ban̅uelos, J. A. et al., Environ. Sci. Technol. 2013, 47, 7927-7933) processes. EF has yielded a high regeneration efficiency and produces its own reagent in situ via a 2-electron cathodic reduction of oxygen gas to H₂O₂ (eq. (1)). The electrogenerated H₂O₂ then reacts with ferrous ions to generate the .OH radicals (eq. (2)) and the electrochemical regeneration of ferrous ion ensures the sustainability of the process by recycling the catalyst (eq. (3)) (Brillas, E. et al. Appl. Catal. B Environ. 2015, 166-167, 603-643; and Deng, F. et al., Electrochim. Acta 2018, 272, 176-183). Furthermore, EF can be coupled with anodic oxidation using a high oxygen overpotential anode, such as boron doped diamond (BDD), to further enhance the mineralization efficiency with additional .OH radicals produced at the anode surface (eq. (4)) (Barhoumi, N. et al., Water Res. 2016, 94, 52-61; and Martinez-Huitle, C. A. et al., Chem. Rev. 2015, 115, 13362-13407).

O₂+2H⁺+2e⁻→H₂O₂ (1)

Fe²⁺+H₂O₂→Fe³⁺+.OH+⁻OH (2)

Fe³⁺+e⁻→Fe²⁺ (3)

BDD+H₂O→BDD(.OH)+H⁺+e⁻ (4)

The combination of high chemical resistance and large surface area make carbonaceous materials the best cathodes to carry out the reduction of oxygen to H₂O₂ (Garcia-Rodriguez, O. et al., Electrochim. Acta 2018, 276, 12-20), making AC a promising material not just for adsorption but also for electrochemical processes (Bañuelos, J. A. et al., Electrochim. Acta 2014, 140, 412-418). However, most reports carried out the saturation and regeneration of AC in separate vessels (Karabacakoğlu, B. et al., Ind. Eng. Chem. Res. 2014, 53, 13171-13179), implying additional logistic costs and constraints. In the few instances where the regeneration and adsorption took place in the same reactor, it was done in batch mode (Bañuelos, J. A. et al., Environ. Sci. Technol. 2013, 47, 7927-7933; and Zhou, W. et al., Electrochim. Acta 2019, 296, 317-326), yet operation in continuous-flow systems is a requirement prior to industrial applications.

Therefore, there is a need to develop a novel reactor design that allows continuous wastewater treatment through adsorption and in situ electrochemical regeneration of AC produced from organic wastes.

### SUMMARY OF INVENTION

Aspects and embodiments of the current invention will now be described by reference to the following numbered clauses.

1. A wastewater treatment reactor for use in electrochemical advanced oxidation processes, the reactor comprising:
a cathode;
an anode; and
a separator situated between the cathode and anode, wherein
   the cathode comprises:
      one or more fixed bed compartments, each of which has an inlet and an outlet for the passage of a wastewater;
      a carbon brush situated in each of the one or more fixed bed compartments; and
      activated carbon situated in each of the one or more fixed bed compartments,
where each carbon brush and activated carbon situated in each of the one or more fixed bed compartments are arranged within the compartment to contact a wastewater passing from the inlet to the outlet;
provided that, when there are two or more fixed bed compartments, the fixed bed compartments are arranged to operate in parallel to one another and not in series.

2. The reactor according to Clause 1, wherein each of the one or more fixed bed compartments has a height/diameter ratio of from 8 to 12, such as 10.

3. The reactor according to Clause 1 or Clause 2, wherein the activated carbon is provided in the form of granules.

4. The reactor according to any one of the preceding clauses, wherein the activated carbon is provided in an amount of from 0.05 to 5 g (such as from 0.1 to 1 g, such as 0.2 g) per cubic centimetre of volume in each of the one or more fixed bed compartments.

5. The reactor according to any one of the preceding clauses, wherein the separator fixes the carbon brushes and activated carbon in the one or more fixed bed compartments.

6. The reactor according to any one of the preceding clauses, wherein the separator comprises a frame and a carbon cloth or a metal mesh (e.g. a stainless steel mesh) disposed within the frame, such that the carbon cloth or metal mesh contacts the cathode and anode.

7. The reactor according to any one of the preceding clauses, wherein the anode is formed of boron doped diamond.

8. The reactor according to any one of the preceding clauses, wherein each inlet of the one or more fixed bed compartments of the cathode has a height of 20 cm, a width of 2.5 cm and a depth of 1 cm.

9. The reactor according to any one of the preceding clauses, wherein the one or more fixed bed compartments of the cathode are three fixed bed compartments.

10. The reactor according to any one of the preceding clauses, wherein the reactor comprises part of a wastewater treatment apparatus, the apparatus further comprising a wastewater source in fluid communication with each inlet of the one or more fixed bed compartments of the cathode, a power supply connected to the cathode and anode and a treated water receptacle in fluid communication with each outlet of the one or more fixed bed compartments of the cathode.

11. A method of wastewater treatment comprising the steps of:

(a) a decontamination stage, where a wastewater comprising at least one contaminant is continuously supplied to a wastewater treatment apparatus as described in Clause 10, comprising a reactor according to any one of Clauses 1 to 9, such that the wastewater enters through an inlet of one of the one or more fixed bed compartments of the cathode and is subjected to an electrochemical advanced oxidation process to remove the contaminant, such that the water passing through an outlet of the one or more fixed bed compartments of the cathode is a decontaminated water that has substantially none of the at least one contaminant present;

(b) a regeneration step, where the decontamination process of step (a) is stopped when a breakthrough amount of the at least one contaminant is detected and the reactor of any one of Clauses 1 to 9 is then placed into an electrochemical regeneration cycle; and

(c) repeating steps (a) and (b).

12. The method according to Clause 11, wherein the, optionally wherein these flow rates relate to a reactor as described in Clause 8 and the flow rate used in a reactor according to any one of Clauses 1 to 7, Clause 9 as dependent upon any one of Clauses 1 to 7 and Clause 10 as dependent upon Clauses 1 to 7 and 9 as dependent upon any one of Clauses 1 to 7 with a differing dimension is pro-rated accordingly.

13. The method according to Clause 11 or Clause 12, wherein the current applied in the electrochemical advanced oxidation process is from 1 to 30 mA/g, such as from 10 to 25 mA/g, such as from 15 to 18 mA/g, such as 16.6 mA/g.

14. The method according to any one of Clauses 11 to 13, wherein the electrochemical advanced oxidation process is an electro-Fenton process.

15. The method according to any one of Clauses 11 to 14, wherein the electrochemical regeneration cycle of the regeneration step is conducted for a period of from 10 to 180 minutes, such as from 30 to 140 minutes, such as from 60 to 130 minutes, such as 120 minutes.

16. The method according to Clause 15, wherein the electrochemical regeneration cycle of the regeneration step is conducted on activated that has reached from 18 to 50% of its theoretical loading capacity, such as from 30 to 40% of its theoretical loading capacity, such as about 38% of its theoretical loading capacity.

17. The method according to any one of Clauses 11 to 16, wherein steps (a) and (b) can be conducted from 10 to 10,000 times, such as from 10 to 500 times, such as from 10 to 100 times, such as 10 times.

### DRAWINGS

FIG. 1 shows the comparison of Langmuir and Freundlich adsorption isotherm models against experimental phenol adsorption equilibrium data (AC=0.1 g, 50 mL of phenol solution and 298 K).

FIG. 2 depicts A) electrochemical reactor scheme; and B) reactor set-up for adsorption and electrochemical regeneration of AC.

FIG. 3 shows the effect of inlet flow rate on the outlet concentration of phenol (10 mM phenol solution and 30 g of AC).

FIG. 4 shows the effect of applied current in H₂O₂ accumulation and its current efficiency after 10 min of electrolysis (inlet).

FIG. 5 depicts the regeneration efficiency and energy consumption for AC after 1 (AC-1 h), 2 (AC-2 h) and 8 (AC-8 h) hours of adsorption.

FIG. 6 depicts the adsorption and regeneration cycles using AC-2 h and AC-8 h.

FIG. 7 shows A) Simplified phenol oxidation pathways during AC electrochemical regeneration process; and B) mass spectrum of extracted compounds from AC-8 h after electrochemical regeneration.

FIG. 8 depicts the Nyquist plot of original AC, AC-8 h and AC-2 h before and after regeneration cycles (inset: equivalent circuit).

FIG. 9 shows the FESEM images of A) the original AC; and B) AC-2 h after 10 cycles of adsorption and regeneration.

FIG. 10 shows A) N₂ adsorption-desorption BET isotherms; and B) pore size distribution curves for fresh AC and AC-2 h after electrochemical regeneration cycles.

FIG. 11 shows the deconvolution of C1s peak from XPS spectra for the A) original AC; and B) AC-2 h after 10 regeneration cycles.

### DESCRIPTION

In view of the issues and limitations mentioned above, it has been surprisingly found that a continuous flow reactor can be designed and operated that allows continuous wastewater treatment through adsorption and in-situ electrochemical regeneration of activated carbon produced from organic waste. Thus, in a first aspect of the invention, there is provided a wastewater treatment reactor for use in electrochemical advanced oxidation processes, the reactor comprising:
a cathode;
an anode; and
a separator situated between the cathode and anode, wherein
   the cathode comprises:
      one or more fixed bed compartments, each of which has an inlet and an outlet for the passage of a wastewater;
      a carbon brush situated in each of the one or more fixed bed compartments; and
      activated carbon situated in each of the one or more fixed bed compartments,
where each carbon brush and activated carbon situated in each of the one or more fixed bed compartments are arranged within the compartment to contact a wastewater passing from the inlet to the outlet;
provided that, when there are two or more fixed bed compartments, the fixed bed compartments are arranged to operate in parallel to one another and not in series.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The phrase, “consists essentially of” and its pseudonyms may be interpreted herein to refer to a material where minor impurities may be present. For example, the material may be greater than or equal to 90% pure, such as greater than 95% pure, such as greater than 97% pure, such as greater than 99% pure, such as greater than 99.9% pure, such as greater than 99.99% pure, such as greater than 99.999% pure, such as 100% pure.

The fixed bed compartments may have any suitable size or dimension. While any suitable shape may also be used for the fixed bed compartments, it is noted that, as the compartments are intended for continuous flow application, they may be cylindrical or, more particularly, cuboidal in shape (e.g. cylindrical). For example, in embodiments that may be mentioned herein, each of the one or more fixed bed compartments may have a height/diameter ratio of from 8 to 12, such as 10. As will be appreciated, when the compartments are cylindrical, the diameter is simply the inner diameter of the compartment. In embodiments where the compartment is cuboidal, the diameter may instead refer to the largest distance between any two edges of a cross sectional place of the cuboid. A reactor according to the current invention may have any suitable number of fixed bed compartments. For example, the reactor may have from 1 to 10 compartments, such as from 2 to 5 compartments, such as 3 compartments.

The activated carbon may be provided in any suitable form within the fixed bed compartments. For example, in embodiments that may be mentioned herein, the activated carbon may be in the form of granules. Any suitable size of granules may be used, for example the activate carbon granules may have a size of greater than 0.9 mm. Other forms of activated carbon that may be suitable include powdered activated carbon.

The amount of activated carbon used will depend on the volume of the fixed bed container. For example, activated carbon may be provided in an amount of from 0.05 to 5 g (such as from 0.1 to 1 g, such as 0.2 g) per cubic centimetre of volume in each of the one or more fixed bed compartments. Thus, in the example fixed bed compartment mentioned hereinbefore (having a height of 20 cm, a width of 2.5 cm and a depth of 1 cm), each fixed bed compartment may contain 10 g of activated carbon, along with a carbon brush (where the carbon brush may be 20 cm in length and 2 cm in diameter).

In order to ensure a reaction occurs, the fixed bed compartments may have an open face that faces towards the anode. As such, the activated carbon (and perhaps the carbon brushes) might be dislodged from the fixed bed compartments when used. To prevent this, the separator may fix the carbon brushes and activated carbon in the one or more fixed bed compartments. Any suitable material (or combination of materials) may be used as a separator in the current invention. For example, the separator may comprise a frame (e.g. a rubber frame) and a carbon cloth or a metal mesh (e.g. a stainless steel mesh) disposed within the frame, such that the carbon cloth or metal mesh contacts the cathode and anode. It will be appreciated that the carbon cloth or metal mesh can be replaced by any other suitable conductive material that provides the desired conductivity, while also serving to prevent dislodgement of the activated carbon and/or the carbon brushes.

Any suitable material may be used as the anode. For example, the anode may be formed from boron doped diamond.

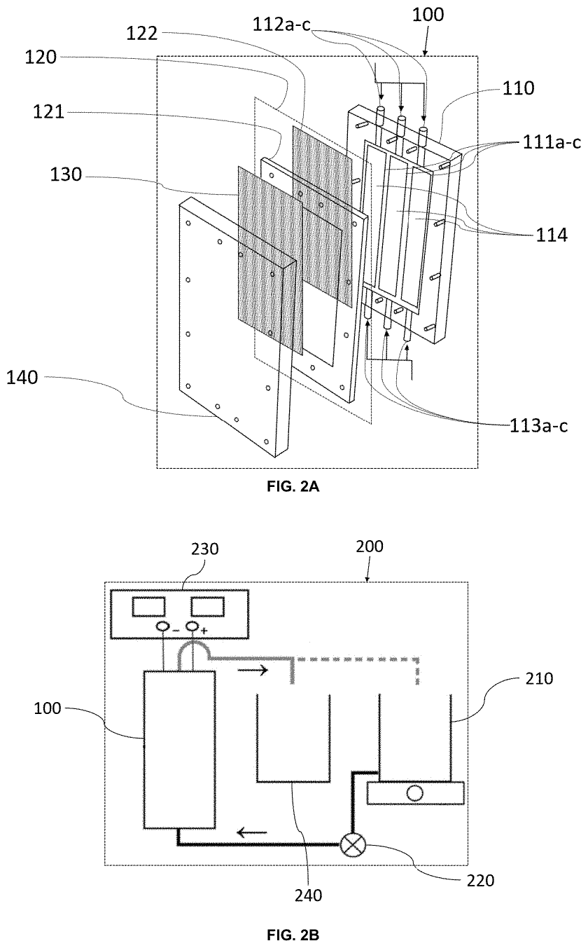

A reactor according to the current invention will now be described by reference to FIG. 2A. FIG. 2A depicts a reactor 100 having a cathode 110 having three fixed bed compartments 111a-c, each of the compartments has an inlet 112a-c and an outlet 113a-c, with activated carbon granules and a carbon brush 114 (the activated carbon and brush are depicted together for simplicity) present in each compartment. As will be appreciated, each of the compartments 111a-c has one open face pointed towards the anode 130 to facilitate the desired reaction. Each of the open faced fixed bed compartments 111a-c in the cathode 110 may have a height of 20 cm, a width of 2.5 cm and a depth of 1 cm. Each of the open faced fixed bed compartments 111a-c also contains a carbon brush that is 20 cm in length and 2 cm in diameter and 10 g of activated.

To prevent spillage and leaching of the activated carbon and the carbon brushes from the fixed bed compartments in the cathode, a separator 120 is used in this embodiment. In this embodiment, the separator takes the form of a frame 121 (e.g. a rubber frame) and a carbon cloth 122 disposed within the frame 121, such that the carbon cloth contacts the cathode and anode when in use. The anode 130 is formed from boron doped diamond (BDD), where two BDD plates with a total area of 200 cm² are placed parallel to the cathode with a gap of 0.5 cm. A backplate 140 that can be secured onto the cathode through the rubber frame is also used to secure all of the components together.

The reactor described hereinbefore may be useful as part of a wastewater treatment apparatus. As such, and as depicted in FIG. 2B the reactor 100 may comprise part of a wastewater treatment apparatus 200, with the apparatus further comprising a wastewater source 210 in fluid communication with each inlet of the one or more fixed bed compartments of the cathode using a peristaltic pump 220, a power supply 230 connected to the cathode and anode and a treated water receptacle 240 in fluid communication with each outlet of the one or more fixed bed compartments of the cathode.

As will be appreciated, there may be multiple reactors in a wastewater treatment apparatus, such that the system allows for a reactor to be regenerated, while other reactors are used in the desired decontamination reaction.

As will be appreciated, the reactor described hereinbefore is intended for use in wastewater treatment. As such, a further aspect of the current invention is the provision of a method of wastewater treatment comprising the steps of:

(a) a decontamination stage, where a wastewater comprising at least one contaminant is continuously supplied to a wastewater treatment apparatus as described herein, comprising a reactor as described herein, such that the wastewater enters through an inlet of one of the one or more fixed bed compartments of the cathode and is subjected to an electrochemical advanced oxidation process to remove the contaminant, such that the water passing through an outlet of the one or more fixed bed compartments of the cathode is a decontaminated water that has substantially none of the at least one contaminant present;

(b) a regeneration step, where the decontamination process of step (a) is stopped when a breakthrough amount of the at least one contaminant is detected and the reactor as described herein is then placed into an electrochemical regeneration cycle; and

(c) repeating steps (a) and (b).

As will be appreciated, the current invention may relate to any wastewater that contains a waste product suitable to be treated by the methods disclosed herein. For example, the wastewater may be a domestic wastewater or, more particularly, the wastewater may be an industrial wastewater. Examples of domestic and industrial wastewaters that may be mentioned herein may be ones in which the contaminant may be an organic compound, such as phenol or derivatives thereof.

While the reactor described herein is intended to be used for wastewater treatment, it may also be configured for other uses. For example, for the trapping of contaminants in a fridge. In this arrangement, the activated carbon may act as a filter and an adsorbent of a fluid (in this case the air in the fridge), thereby trapping contaminants that may give rise to unpleasant odours. As discussed herein, the activated carbon in this application may be regenerated using the methods described herein. It will be appreciated that the configuration of the reactor used in this application may be identical to that described for used in wastewater and in this case, the contaminated air may be seen as the wastewater, as it is a fluid that passes through the reactor.

When used herein, the term “substantially none” is intended to refer to a reduction of the at least contaminant that is at least a 95% reduction, such as at least a 96.5% reduction, such as at least a 97% reduction, such as at least a 99% reduction, such as at least a 99.5% reduction, such as at least a 99.9% reduction, such as a 100% reduction of the contaminant compared to the original value within the wastewater.

When used herein, the term “breakthrough amount” refers to the level when the amount of the at least one contaminant is considered to be over a desired level as determined by the contaminant and the end use of the water. For example, the breakthrough amount may refer to the present of 0.1% of the at least one contaminant, such as 0.5%, such as 1%, such as 2% etc. As will be appreciated, the breakthrough amount will depend in part on the contaminant(s) in question and the desired end use of the water and can be readily determined by the person skilled in the art.

Any suitable flow rate of the wastewater may be used in the method described above. For example, the flow rate of the wastewater continuously supplied to the wastewater treatment apparatus is from 5 to 40 mL/min, such as from 8 to 14 ml/min, such as from 8 to 10 mL/min. In particular, these flow rates may be suited to the reactor discussed in relation to FIG. 2A above (i.e. each fixed bed compartment having a height of 20 cm, a width of 2.5 cm and a depth of 1 cm, each fixed bed compartment containing 10 g of activated carbon, along with a carbon brush (where the carbon brush may be 20 cm in length and 2 cm in diameter).

As will be appreciated, the exact flow rate of the wastewater may be changed to match the dimensions of fixed bed compartments used. When this is the case, the change in flow rate may be pro-rated based on the flow rates mentioned above in relation to the reactor discussed in relation to FIG. 2A above.

Any suitable current may be used to conduct the electrochemical advanced oxidation process. For example, the current may be from 1 to 30 mA/g, such as from 10 to 25 mA/g, such as from 15 to 18 mA/g, such as 16.6 mA/g. In embodiments of the invention that may be mentioned herein, the electrochemical advanced oxidation process may be an electro-Fenton process.

As noted the current reactor may be regenerated. This electrochemical regeneration cycle may be conducted for any suitable period of time. For example, the wherein the electrochemical regeneration cycle of the regeneration step may be conducted for a period of from 10 to 180 minutes, such as from 30 to 140 minutes, such as from 60 to 130 minutes, such as 120 minutes. While not wishing to be bound by theory, it is believed that the electrochemical regeneration cycle may be more sustainable (in that more cycles may be conducted) if the electrochemical regeneration cycle of the regeneration step is conducted on activated carbon that has reached only up to about 50% of its theoretical loading capacity. For example, the activated carbon may have reach from 18 to 50% of its theoretical loading capacity, such as from 30 to 40% of its theoretical loading capacity, such as about 38% of its theoretical loading capacity.

The method described herein may be conducted as many times as possible—that is, up to the point where the activated carbon has been exhausted. For example, steps (a) and (b) of the method may be conducted from 10 to 10,000 times, such as from 10 to 500 times, such as from 10 to 100 times, such as 10 times. When used herein, “exhausted” may take its normal meaning in the art. Additionally or alternatively, the term “exhausted” when used herein may refer to the point where the activated carbon cannot be regenerated to provide a desired level of adsorption anymore.

Further aspects and embodiments of the invention will now be discussed by reference to the following non-limiting examples.

### EXAMPLES

Materials

Potassium sulfate (K₂SO₄), titanium (IV) oxysulfate-sulfuric acid solution (TiOSO₄.(H₂SO₄)ₓ), sulfuric acid (H₂SO₄), phenol (C₆H₅OH), diethyl ether ((CH₃CH₂)₂O) and iron (II) sulfate heptahydrate (FeSO₄.7H₂O) were purchased from Sigma-Aldrich (Singapore) and used without any further modification. All solutions were prepared with high-purity water from a Millipore Milli-Q system (resistivity>18 MΩ cm at room temperature). Boron doped diamond (BDD) electrodes were obtained from Condias (Germany) and carbon cloth made of graphitized spun yarn with a count of 38×38 yarns in⁻¹ from Fuel Cell Earth (USA). Carbon brushes were made of PAN-carbon fibers (SGL group, USA) with a stainless steel wire as current collector.

Analytical Techniques

The charge transfer resistance of the activated carbon (AC) was evaluated by electrochemical impedance spectroscopy (EIS) in an electrochemical cell with a three-electrode set-up using a potentiostat/galvanostat Autolab PGSTAT204 equipped with an EIS module FRA32 M (Metrohm Ltd, Switzerland). Carbon paste electrodes were prepared with the AC following the method of Banuelos et al. (Bañuelos, J. A. et al., Environ. Sot. Technol. 2013, 47, 7927-7933) and used as working electrodes. Ag/AgCl (3 M NaCl) and BDD were used as reference and counter electrodes, respectively. The electrolytic solution consisted of 50 mM K₂SO₄ at pH 3.

The specific surface area was determined using the Brunauere-Emmette-Teller (BET) method under N₂ adsorption/desorption isotherms at 77 K. The Horvath-Kawazoe and Barrett-Joyner Halenda methods (Sing, K. S. W. et al., Pure Appl. Chem. 1982, 54, 2201-2218) were used to characterize the microporosity and mesoporosity, respectively. The analysis was done using an ASAP 2010 Micromeritics Analyzer (Micromeritics Instrument Corp., USA). Samples were degassed at 623 K for 48 h prior to adsorption. A field emission scanning electron microscope (FESEM, JEOL JSM-6701F, USA) was used to characterize the surface morphology of the AC. The surface elemental composition was obtained by X-ray photoelectron spectroscopy (XPS) using a Kratos AXIS Ultra^{DLD} spectrometer (UK) with a monochromatic radiation Al Kα (hv=1486.7 eV). The peaks of the XPS spectra were fitted with OriginPro 9.0 software. Matrix-assisted laser desorption ionization time-of-flight (MALDI-TOF) mass spectrometry of the extracted compounds from the AC after electrolysis was performed using an Autoflex II mass spectrometer (Brucker-Daltonics GmbH, Bremen, Germany). The samples were prepared by extraction with diethyl ether as solvent, following the procedure described by Cooney et al. (Cooney, D. O. et al., Water Res. 1983, 17, 403-410).

### Example 1

AC was prepared by direct activation with steam, using biochar from yard trimmings waste as raw material. For each batch, 100 g of biochar were placed in a semi-rotating quartz tube under a nitrogen flux (0.5 L min⁻¹) with a ramp of temperature of 10° C. min⁻¹ until 800° C. At this constant temperature, steam was added (1.2 mL min⁻¹) for 80 min to the nitrogen flux.

Then, cooling was allowed under nitrogen flux until ambient temperature. The obtained AC was rinsed with deionized water until a constant pH was attained and dried at 105° C. Finally, AC was sieved with a mesh to only retain particles with size above 0.9 mm, which were used in this study.

General Procedure 1

The reactor design and experimental set-ups are described below.

The reactor was designed with two purposes in mind: the continuous adsorption of the model pollutant using AC and the electrochemical regeneration of the used adsorbent. The reactor scheme is shown in FIG. 2A. The cathode consisted of 30 g of AC alongside three carbon brushes (20 cm length, 2 cm diameter) working as current collectors. They were packed in three compartments (10 g of AC in each compartment) with a height of 20 cm, width of 2.5 cm and depth of 1 cm, within the recommended range of height/diameter ratio (between 8 and 12) to ensure good adsorption in a fixed-bed column (Bayat, M. et al., Environ. Technol. Innovat. 2018, 12, 148-159; Marinović, V. et al., J. Hazard Mater. 2005, 117, 121-128; and Lei, G. et al., J. Chem. Eng. Data 2016, 61, 2499-2509). A sheet of carbon cloth with a rubber frame was used to maintain and compress the AC granules in their intended compartment. The anode consisted of two BDD plates with a total area of 200 cm² placed parallel to the cathode with a gap of 0.5 cm. The reactor was operated with two distinct configurations shown in FIG. 2B. A continuous flow was used for the adsorption process. On the other hand, the reactor was switched to a recirculation mode during the electrochemical experiments, with the aim to minimize the amount of electrolyte needed (400 mL of 50 mM K₂SO₄ at pH 3).

Phenol Adsorption Experiments

The adsorption isotherms were first obtained through batch adsorption tests. 0.1 g of AC were added to 50 mL of phenol solutions with concentrations between 5 and 1000 mg L⁻¹. The flasks were sealed and placed in an orbital shaking incubator (LM-450D Yihder Co. Ltd, Taiwan) at 160 rpm and 298 K for 48 h, allowing sufficient time to achieve equilibrium. The samples were filtered using a 0.45 mm PTFE membrane and their phenol concentration was determined by reverse-phase high-performance liquid chromatography (HPLC, Shimadzu SCL-10A, Japan) equipped with an Agilent extend-C18 column (150 mm×2.10 mm, 5 mm). Acetic acid (1%) and methanol (75:25, v/v) were used as the mobile phase with a flow rate of 0.25 mL min⁻¹. The detection wavelength was set at 280 nm, controlled by a UV-absorbance detector (Shimadzu SPD-M 10A, Japan). The concentration of phenol in solution at equilibrium (Cₑ, mg L⁻¹) and its initial concentration before adsorption (Cₒ, mg L⁻¹) were used to calculate the amount of phenol adsorbed per unit of AC at equilibrium (qₑ, mg g⁻¹), following eq. (5), and the data was fitted to Langmuir and Freundlich isotherms.

qₑ=(Cₒ−Cₑ)V W⁻¹ (5)

where V is the volume of solution (L) and W is the mass of AC (g).

The performance of the reactor in continuous flow was then evaluated by establishing breakthrough curves at different flow rates (8, 10, 14 and 20 mL min⁻¹). A 10 mM phenol solution, within the typical concentration range of industrial phenolic wastewaters (Steevensz, A. et al., Enzym. Microb. Technol. 2014, 55, 65-71), flowed upwards through the reactor using a peristaltic pump (Masterflex L/S Cole-Parmer, USA) and samples were taken from the effluent at regular time intervals. Phenol concentration was then measured by HPLC, following the methodology described above. The amount of phenol adsorbed onto the AC was calculated through data integration.

Hydrogen Peroxide Production and AC Electrochemical Regeneration

The optimum current density (between 1 and 25 mA g⁻¹) was assessed through the monitoring of electrochemical H₂O₂ generation. For this purpose, electrolysis tests were carried out in the electrochemical reactor in recirculation mode, with 400 mL of electrolyte (50 mM K₂SO₄ at pH 3) and continuous air bubbling, pumped through the reactor at a flow rate of 10 mL min⁻¹. Samples were withdrawn every 5 min for a period of half an hour and H₂O₂ was quantified using a photospectrometric method based on the addition of titanium oxysulfate to the solution sample to form a complex whose color intensity was measured at a wavelength of 405 nm (Garcia-Rodriguez, O. et al., Electrochim. Acta 2018, 276, 12-20). The current efficiency (CE) for H₂O₂ generation was determined by eq. (6) (Brillas, E. et al., Chem. Rev. 2009, 109, 6570-6631).

$$C E = \frac{Fnc ( {H}_{2} {O}_{2} ) V}{M ( {H}_{2} {O}_{2} ) 1000 Q} \times 100 \qquad ( 6 )$$

where F is the Faraday's constant (96 487 C mol⁻¹), n refers to the stoichiometric number of electrons transferred in the oxygen reduction, c(H₂O₂) is the accumulated H₂O₂ concentration (mg L⁻¹), V corresponds to the volume of the electrolyte (L), M(H₂O₂) refers to the molecular weight of H₂O₂ (34 g mol⁻¹), 1000 is a conversion factor and Q stands for the charge that was used during the electrolysis.

Electrochemical regeneration experiments of AC were carried out in recirculation mode (flow rate of 10 mL min⁻¹) at a constant current of 16.6 mA g⁻¹. The source of ferrous ions consisted of iron (II) sulfate heptahydrate added to the electrolyte (50 mM K₂SO₄ at pH 3) to obtain a 0.2 mM iron (II) concentration. The regeneration efficiency was evaluated by varying the electrolysis time (impacting on the amount of AC saturated in the column), as well as the number of adsorption-regeneration cycles. First, the adsorption process was carried out to obtain different loadings of saturated AC in the reactor. Then, the electrochemical regeneration process took place by varying the electrolysis time from 60 to 120 min. Finally, the adsorption process was carried out again and the concentration of phenol in the effluent was compared to that of the first adsorption cycle to assess the regeneration efficiency. The energy consumption (EC) was calculated using equation (7), where E_{cell} corresponds to the potential difference through the regeneration (V), I stands for the applied current (A), t refers to the treatment time (h), ACₘₐₛₛ is the mass of AC in the electrochemical reactor (kg) and 1000 is a conversion factor:

$$EC ( k Wh {kg}^{- 1} ) = \frac{{E}_{cell} \vert t}{1000 {AC}_{m a s s}} \qquad ( 7 )$$

### Example 2

In order to get an overall understanding of its properties in terms of adsorption capacity, a preliminary batch adsorption characterization of the new adsorption material (prepared in Example 1) was conducted as described in the phenol adsorption experimental section in General Procedure 1.

Results and Discussion

Langmuir and Freundlich isotherm adsorption models are simple and explicit, and are commonly employed in AC adsorption studies with phenol (Du, W. et al., RSC Adv. 2017, 7, 46629-46635), with the aim of obtaining a better understanding of the adsorption behavior of the adsorbate and determine important parameters such as the adsorption capacity of the material, inter alia. As reported widely, the Langmuir isotherm model is representative of a monolayer adsorption onto an adsorbent, assuming a lack of interaction between the adsorbed molecules on the surface of the adsorbent (Trellu, C. et al., Environ. Sci. Technol. 2018, 52, 7450-7457). On the other hand, the Freundlich model is applicable to a multilayer adsorption onto an adsorbent with a highly heterogeneous surface (Kundu, S. et al., J. Chem. Eng. Data 2018, 63, 559-573).

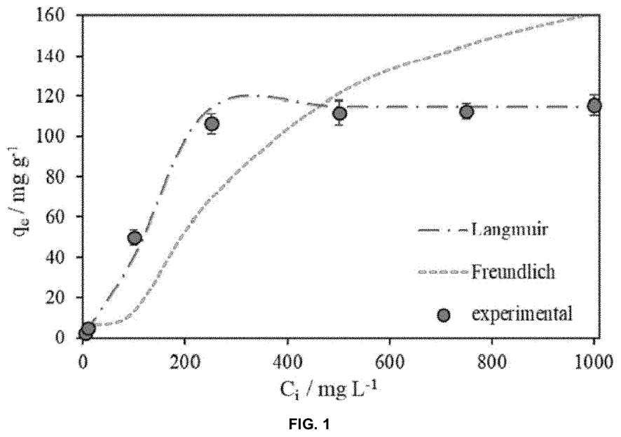

Experimental data for phenol adsorption after reaching equilibrium with different initial concentrations is represented by circles in FIG. 1 while the Langmuir and Freundlich models are represented by the dash and dash-dot lines, respectively. Their parameters were obtained by fitting the adsorption equilibrium data to the mathematical forms shown in Table 1.

TABLE 1
Langmuir and Freundlich adsorption isotherm models and their
corresponding fitted parameter values for phenol adsorption.

| Isotherm mode | Mathematical form | Parameters^{a} | | r² |
|---|---|---|---|---|
| Langmuir | ${q}_{e} = \frac{{q}_{max} {bC}_{e}}{1 + {bC}_{e}}$ | qₘₐₓ/mg g⁻¹ b/L mg⁻¹ | 115 5.4 | 0.99 |
| Freundlich | ${q}_{e} = {KC}_{e} \frac{1}{n}$ | K/mg¹⁻ⁿ^{^{−1}} Lⁿ^{^{−1}} g⁻¹ n | 25 3.6 | 0.83 |

^{a}qₘₐₓ represents the maximum monolayer adsorption capacity of phenol, b is the Langmuir constant related to the energy of adsorption, K is the Freundlich constant associated to the adsorption capacity and n the intensity of adsorption, both empirical constants (Kim, Y. -S. et al., J. Chem. Therm. 2019, 130, 104-113; and Yuan, P. et al., Langmuir 2018, 34, 15708-15718).

It is obvious from FIG. 1 that the phenol adsorption data was better explained by the Langmuir isotherm model than by Freundlich, leading to the highest correlation coefficient (r²=0.99, cf. Table 1). This monolayer adsorption behavior is in accordance with previous reports on biomass-derived AC (Fu, Y. et al., Sci. Total Environ. 2019, 646, 1567-1577; and Giraldo, L. et al., J. Anal. Appl. Pyrol. 2014, 106, 41-47). As evidenced before by Mattson et al. (Mattson, J. et al., J. Colloid Interface Sci. 1969, 31, 116-130), the major influence during the adsorption process of phenol and other similar compounds (p-nitrophenol, m-nitrophenol and nitrobenzene) onto AC lies in the interaction between the aromatic ring of these compounds and the surface of the AC. As further demonstrated by Hadi et al. (Hadi, P. et al., Chem. Eng. J. 2015, 269, 20-26), this monolayer formation can be attributed to the stronger attraction between phenol and the carbon surface due to π-π London dispersion forces, rather than H-bonds present in the interaction between phenol-water and phenol-phenol. In turn, a monolayer instead of a multilayer formation is favored.

The maximum adsorption capacity of the AC according to Langmuir was 115 mg g⁻¹, in the range of phenol adsorption for biomass-based AC reported by others, e.g. 85-160 mg g⁻¹ (Nunell, G. V. et al., Adsorption 2016, 22, 347-356), 45 mg g⁻¹ (Xiong, Q. et al., RSC Adv. 2018, 8, 7599-7605), 149 mg g⁻¹ (Hameed, B. H. et al., J. Hazard Mater. 2008, 160, 576-581), 161 mg g⁻¹ (Li, X. et al., Asia Pac. J. Chem. Eng. 2018, 13, e2240), among others. Following these preliminary batch experiments, the optimization of the reactor breakthrough dynamics will aim at approaching this maximum adsorption capacity in a reactor more relevant to practical applications.

### Example 3

Optimization of the operating conditions in the electrochemical reactor described in General Procedure 1 was carried out and the experimental results are provided below.

Results and Discussion

Flow Rate

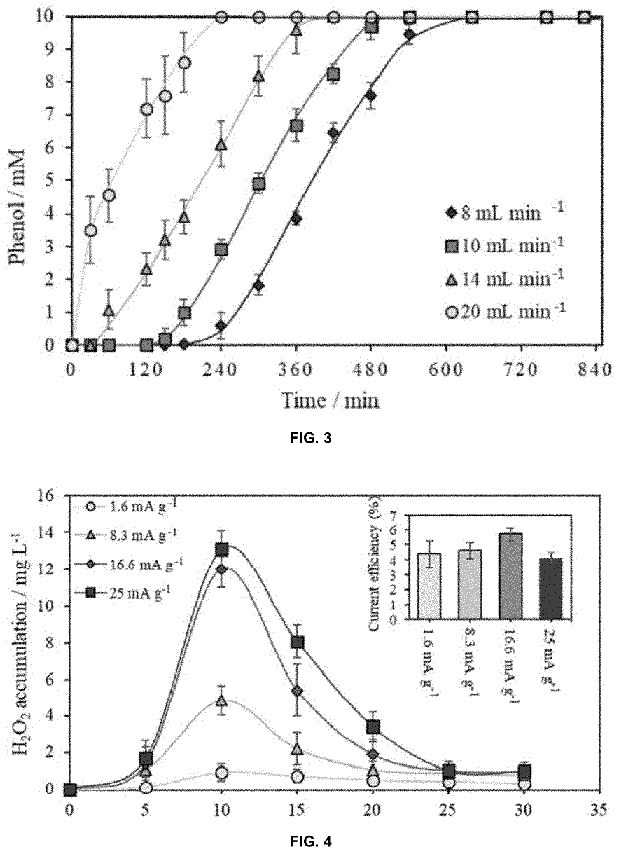

Although there is a vast amount of new adsorbents generated from biomass, the study of these adsorbents is often limited to batch systems. However, column breakthrough dynamics is essential to determine their potential for real wastewater treatment applications. As mentioned above, the design of the reactor emulated three fixed-bed adsorption columns and their response to a continuous flow of a phenol solution was evaluated through breakthrough curves at different flow rates but with the same initial phenol concentration, as shown in FIG. 3. As expected, the increase in flow rate shifted the breakthrough curves towards the left side of the graph, meaning that the exhaustion (saturation above 90%) of AC with phenol was faster at a flow rate of 20 mL min⁻¹ (240 min), while it took 600 min to reach saturation at a flow rate of 8 mL min⁻¹. However, a flow rate above 10 mL min⁻¹ had a negative effect on the adsorption capacity of the AC in the reactor.

Indeed, the uptake capacity of an adsorbent in continuous flow is always lower than in batch, but it is counteracted by the necessity to exert a dynamic mode for real applications. Here, the adsorption capacity, obtained by integrating the breakthrough curve for each flow rate, remained high at lower flow rates of 8 and 10 mL min⁻¹, reaching 104 and 102 mg g⁻¹, respectively (only 10% lower than in the batch study). However, the removal performance dropped considerably at higher flow rates, reaching 90 mg g⁻¹ at 14 mL min⁻¹ (22% lower than in the batch study) and 53 mg g⁻¹ at 20 mL min⁻¹ (a 54% drop). The lower adsorption capacity at high flow rates could be attributed to a degradation of intraparticle mass transfer and formation of dead zones within the reactor and thus, the flow rate was set at 10 mL min⁻¹ for further experiments, in order to maintain an effective mass transfer towards the AC material.

There are three special adsorption points that are easily identified in FIG. 3: (i) the first one at 60 min where only 19% of the total amount of AC is saturated; (ii) the second one at 120 min, just before the breakthrough point when the phenol concentration in the effluent is still close to zero and 38% of the AC is saturated; and (iii) the last point at 480 min corresponding to a fully exhausted AC. These adsorption times will be used in the following examples to study the effect of phenol saturation level in the AC on the electrochemical regeneration efficiency.

Applied Current

Applied current is paramount because it determines both the efficiency of the regeneration process and its cost. FIG. 4 shows H₂O₂ accumulation at different currents between 1.6 and 25 mA g⁻¹. It can be seen that the accumulation of H₂O₂ did not follow a typical behavior, with a gradual accumulation followed by a plateau when the anodic H₂O₂ destruction rate balances its electrogeneration at the cathode (Olvera-Vargas, H. et al., Separ. Purif. Technol. 2018, 203, 143-151). Instead, we observed an accumulation of H₂O₂ (greater at higher applied currents) during the first 10 min of electrolysis, followed by a decay and almost complete depletion after 30 min. This H₂O₂ decay was attributed not only to its oxidation at the anode by eq. 8 and 9 (García-Rodriguez, O. et al., J. ElectroanaL Chem. 2016, 767, 40-48), but also to its activation at the surface of the AC, generating hydroxyl radicals and superoxide radical anions via equations 10 and 11 (Georgi, A. et al., Appl. CataL B Environ. 2005, 58, 9-18). Thus, AC can be used as a catalyst to promote its own regeneration without the need for other chemicals, as shown recently by Zhou et al. (Zhou, W. et al., Electrochim. Acta 2019, 296, 317-326). However, the process efficiency can be greatly increased when combined with catalytic amounts of iron, as shown in the following sections.

H₂O₂→HO₂^{.}+H⁺+e⁻ (8)

HO₂^{.}→O₂(g)+H⁺+e⁻ (9)

AC+H₂O₂→AC⁺+⁻OH+.OH (10)

AC⁺+H₂O₂→AC+HO₂^{.}+H⁺ (11)

The maximum current efficiency for H₂O₂ electrogeneration (inset panel of FIG. 4), was determined after 10 min of electrolysis, corresponding to the peak of accumulation. The lowest current efficiency (4.1%) was obtained at the highest applied current density of 25 mA g⁻¹, due to parasitic side reactions that occur in such conditions (Oturan, M. A. et al., Crit. Rev. Environ. Sci. Technol. 2014, 44, 2577-2641). The highest current efficiency (5.7%) was obtained at a current density of 16.6 mA g⁻¹, which was used in subsequent experiments.

Regeneration Time

The electrolysis time is another key parameter in electrochemical processes, directly correlated to the energy consumption of the process. Thus, the electrochemical regeneration time was optimized in this section using electrolysis times between 60 and 120 min, applied after 1 h, 2 h and 8 h of adsorption, in order to assess the effect of different AC saturation levels within the reactor, as already explained above (cf. FIG. 3). Then, the regeneration process was carried out for different durations from 30 to 120 min. Finally, the adsorption process was carried out again and the concentration of phenol in the effluent was compared to that of the first adsorption cycle to assess the regeneration efficiency.

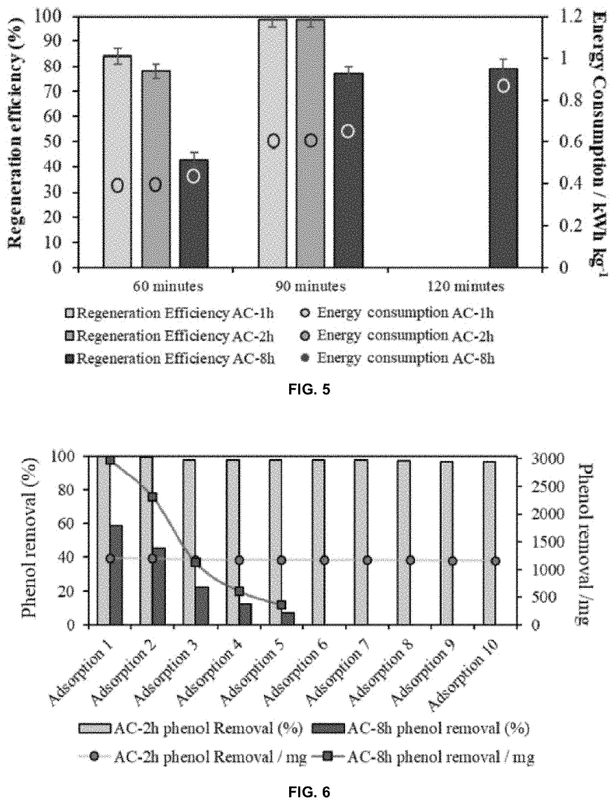

FIG. 5 shows the evolution of energy consumption (EC) and regeneration efficiency (RE) as a function of the regeneration time. When the AC after 1 and 2 h of adsorption (AC-1 h and AC-2 h, respectively) was used, complete regeneration of AC was achieved after 90 min of electrolysis with an EC of 0.6 kWh kg⁻¹. However, the fully saturated AC (AC-8 h) led to a RE of 77±4.2% after 90 min of electrolysis, with no further increase at longer treatment time. This result suggested that the phenol oxidation mechanism differed depending upon the amount of saturated AC in the electrochemical reactor, which hindered its mineralization at the higher load.

From the above results, we can conclude that the adsorption process can take place safely at least for 2 h (breakthrough capacity), corresponding to 38% of saturated AC, while still achieving high regeneration efficiency. Furthermore, it is not desirable to exceed the breakthrough capacity of the reactor in order to avoid concentrations of phenol higher than the permissible discharge limits.

EC is crucial to assess the feasibility of the regeneration process; at the industrial scale, thermal gasification methods suffer from high energy costs due to elevated temperatures (800-900° C.) and may cause AC strcture degradation (Salvador, F. et al., Microporous Mesoporous Mater. 2015, 202, 259-276). Alternative methods, including microwave regeneration, are also costly at 900 kWh kg⁻¹ and 85% of RE (Pan, R. R. et al., RSC Adv. 2016, 6, 32960-32966). In contrast, the range of EC in our study (<1 kWh kg⁻¹ of AC) largely outcompetes these processes. This low EC is further supported by other electrochemical regeneration technologies, including an electro-desorption study conducted by Alvarez-Pugliese et al. (Alvarez-Pugliese, C. E. et al., Diam. Relat. Mater. 2019, 93, 193-199), who achieved>80% regeneration efficiency at only 3.8 kWh kg⁻¹ of AC (with more complex pollutants). It should be noted here that our proposed solution differs from that of Alvarez-Pugliese et al. (Alvarez-Pugliese, C. E. et al., Diam. Relat. Mater. 2019, 93, 193-199), because it relies on a combination of electro-Fenton and anodic oxidation, leading to mineralization of phenol, unlike desorption regeneration methods.

### Example 4

The stability of the optimized electrochemical regeneration process, as described in General Procedure 1 and Example 3, was evaluated.

Results and Discussion

The phenol removal efficiency was monitored during 10 consecutive cycles of adsorption and regeneration using AC-2 h and AC-8 h to study the stability of the regeneration process (FIG. 6). The removal efficiency for AC-2 h remained close to 100% during the 10 cycles, with around 1173 mg of phenol degraded during each cycle. However, when the sequential adsorption-regeneration process was carried out with AC-8 h, a continuous decrease of phenol removal was observed from 60% in the 1st cycle to less than 10% in the 5th cycle. During the first 2 cycles, the amount of phenol removed by AC-8 h was higher than by AC-2 h. Then, the amount of phenol removed by AC-8 h dropped drastically and only 356 mg of phenol were removed by the end of the 5th cycle. Although regeneration studies are usually carried out until the material is exhausted, we demonstrated here for the first time that the amount of saturated AC with phenol within the reactor is a crucial parameter that should be taken into account when performing regeneration by electrochemical oxidation.

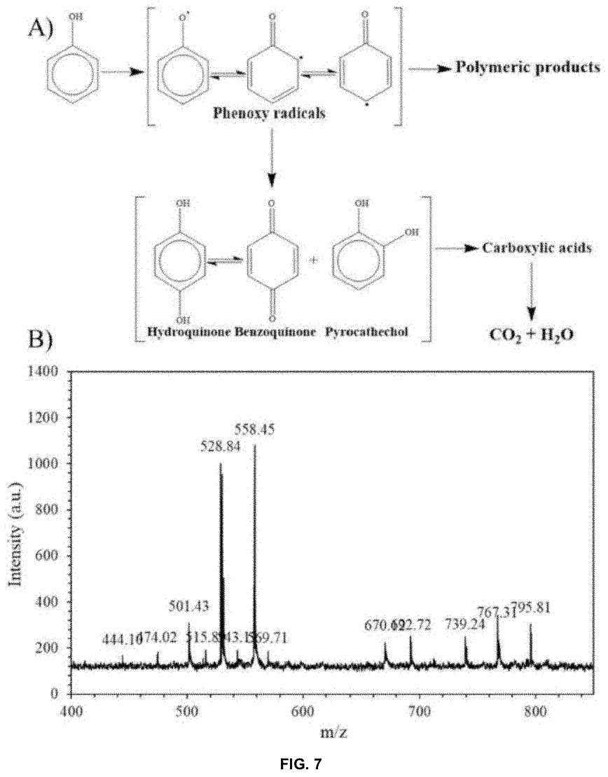

The decay in regeneration efficiency observed for AC-8 h could be attributed to a different phenol oxidation pathway, as mentioned in Example 3. It has been previously reported that phenol oxidation can lead to its mineralization and/or polymerization depending upon the experimental conditions such as concentration, electrode material, applied potential, etc. (Patra, S. et al., J. Electrochem. Soc. 2008, 155, F23-F30). The major steps of the possible phenol oxidation reaction pathways (FIG. 7A) can be simplified as follows: the first step involves the generation of phenoxy radicals as primary oxidation products and further oxidation yields either recalcitrant polymeric products (Nady, H. et al., Egypt. J. Petrol. 2017, 26, 669-678) or quinones and catechols, whose aromatic rings may be cleaved into carboxylic acids (e.g., maleic and oxalic acids) before final mineralization to C_{O}2 (Ma, W. et al., Chem. Eng. J. 2014, 241, 167-174).

### Example 5

In order to get a better understanding of the pathway followed during the electrochemical regeneration (as described in General Procedure 1) of AC-8 h (prepared in Example 1) under optimized conditions (as described in Example 3), a mass spectra analysis of the extracted compounds from the AC was carried out and the organic extract was analyzed by MALDI-TOF.

Results and Discussion

FIG. 7B clearly shows the presence of organic compounds with mass-to-charge ratio (m/z) of 501, 528, 558, 795, among others, corresponding to high molecular weight molecules generated from phenol reactions, e.g. supporting the polymerization hypothesis. Thus, during AC-8 h regeneration, the high amount of adsorbed phenol probably affected the production of oxidants and promoted the polymerization pathway that led to the blockage of the AC pores and subsequent electrode passivation, which not only nulled the regeneration of the AC beyond 90 min of electrolysis (FIG. 5), but it also resulted in the continuous decrease of AC regeneration efficiency between cycles. In contrast, the regeneration of AC-2 h favored the oxidation of the adsorbed phenol molecules by OH radicals, leading to their complete mineralization rather than polymerization and thus lasting regeneration efficiency (FIG. 6).

### Example 6

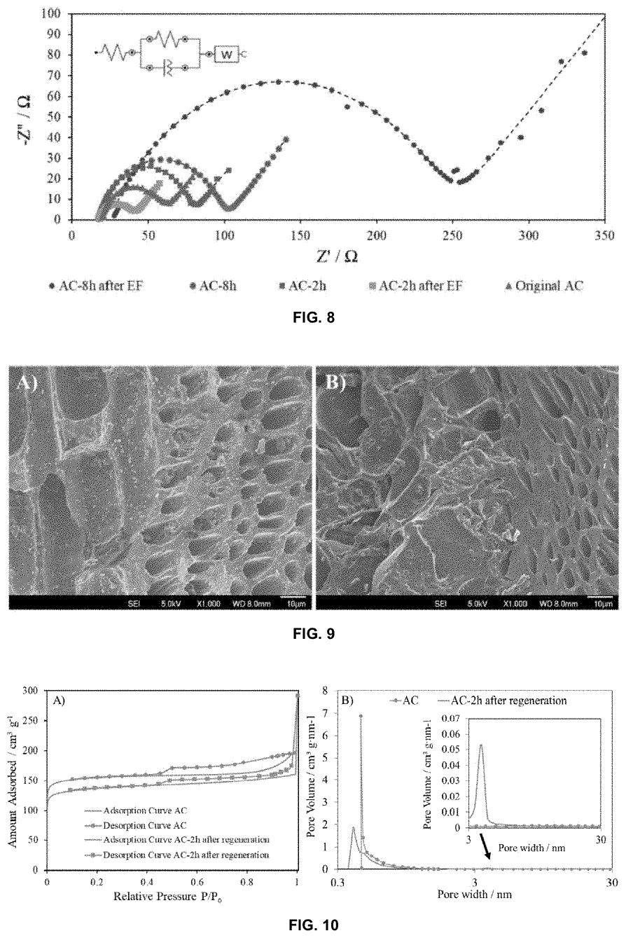

To support the above observations, characterization through EIS, a nondestructive electrochemical method, allowed the following of the behavior of the ACs (prepared in Example 1), original AC, AC-8h and AC-2h, before and after the regeneration cycles performed under optimized conditions (as described in General Procedure 1 and Example 3). The EIS responses were interpreted by fitting the data to an equivalent circuit (inlet of FIG. 8), formed by a constant phase element (CPE) in parallel with a charge transfer resistance (R_{ct}) and an ohmic resistance (R_{Ω}), with an additional finite length diffusion element (W) set at the end of the circuit.

Results and Discussion

FIG. 8 shows that the Nyquist plots of all the AC carbon electrodes display a broad depressed semicircle within the high frequencies, whose diameter is correlated to the interfacial charge-transfer. Comparing the flow of charge across the interface for the different samples of AC, it can be seen that R_{d} increased from 39Ω (original AC) to 64Ω and 83Ω, after the adsorption process was carried out for AC-2h and AC-8h, respectively. These results demonstrated that the adsorbed phenol is detrimental to the interfacial electron transfer rate. Yet, the most dramatic difference in R_{d} was observed after 10 cycles of adsorption-regeneration, where the regenerated AC-2h displayed an almost 3-fold decrease of R_{ct} (from 64 to 22Ω), even below the original AC value. This observation could be attributed not only to the removal of the phenol adsorbed, but also to the cleaning of impurities already present in the AC prior to adsorption. In contrast, the largest semicircle diameter (221Ω) was obtained with the regenerated AC-8h, which could be attributed to the formation of polymeric products, as stated in Example 4 and 5, that passivate the electrode, hinder the charge transfer process and make the regeneration of the AC less effective. These results confirmed that the initial amount of phenol in the AC is critical for its electrochemical regeneration.

### Example 7

To get a better understanding of the effect of the electrochemical regeneration process (as described in General Procedure 1) on the surface of the AC (prepared in Example 1) within the optimal conditions (as described in Example 3), a physicochemical characterization was carried out before and after ten regeneration cycles of AC-2h as one of the main disadvantages of other regeneration methods (especially thermal processes) is the degradation of the AC structure caused by the harsh conditions undergone by the material.

Results and Discussion

The morphological structure of the AC before and after 10 cycles of electrochemical regeneration was analyzed using FESEM (FIG. 9). Small impurities along the surface of the AC were apparent in the micrographs before treatment (FIG. 9A) but were no longer visible after treatment (FIG. 9B), suggesting their effective removal as explained in Example 5. FIG. 9B also shows that the structural integrity of the regenerated AC was preserved.

BET analysis and pore distribution size of AC and AC-2h are shown in FIG. 10. According to Brunauer's classification (Brunauer, S. et al., J. Am. Chem. Soc. 1940, 62, 1723-1732), both samples of AC fall under type IV adsorption isotherms (FIG. 10A), which occurs in adsorbents with pore radius ranging between 1.5 and 100 nm (Lowell, S. et al., Adsorption isotherms, in: Powder Surface Area and Porosity, 1984, 11-13). The hysteresis in the isotherms indicated the presence of mesopores. However, real porous materials usually present a combination of pores of different sizes. In this case, the presence of micropores was created by physical steam activation [correct?] (Tennant, M. F. et al., Carbon 2003, 41, 2195-2202). These micropores were apparent at low adsorbate pressure, leading to an isotherm that also resembled type I adsorption isotherms [correct?] (Schneider, P. Appl. CataL Gen. 1995, 129, 157-165). This conclusion is further supported by the pore size distribution (FIG. 10B), showing the prominence of micropores (<2 nm) before and after regeneration. The fresh AC presented a modal pore distribution centered around 0.44 nm, with a heterogeneous mesopore distribution. However, after electrochemical regeneration, the micropore distribution size broadened and the mesopores became centered around 3.7 nm (see inlet of FIG. 10B). Furthermore, AC-2h showed a decrease of 21% in the total volume (Vₜₒₜₐₗ) of the pores, total, associated with a loss of 27% of specific surface area, following electrochemical regeneration (Table 2). Additionally, the micropore volume which generally governs phenol adsorption (Lorenc-Grabowska, E. Adsorption 2016, 22, 599-607) was reduced by 22%. Nevertheless, the adsorption capacity was maintained over the 10 adsorption cycles, indicating that the mesopore volume (which increased by 114%) played a key role in the adsorption process by enhancing the diffusion via new transport pathways of lower resistance (Schneider, D. et al., Chem. Soc. Rev. 2016, 45, 3439-3467), thus improving pore accessibility and overall mass transfers. These results showed that electrochemical treatment had an impact on the pore distribution size, where the micropore ratio is reduced for the benefit of mesopores.

TABLE 2
BET analysis of the original AC and AC-2 h
after 10 cycles of adsorption and
electrochemical regeneration.

| | Mesopores | Micropores | | |
|---|---|---|---|---|
| | volumes^{a} | volumes^{a} | Vₜₒₜₐₗ | S_{specific} |
| | (cm³ g⁻¹) | (cm³ g⁻¹) | (cm³ g⁻¹) | (cm³ g⁻¹) |
| Original | 0.033 | 0.220 | 0.315 | 575 |
| AC | | | | |
| AC-2 h | 0.071 | 0.172 | 0.248 | 419 |
| after cycles | | | | |

^{a}According to IUPAC, micropore diameters < 2 nm; 2 nm < mesopore diameters < 50 nm.

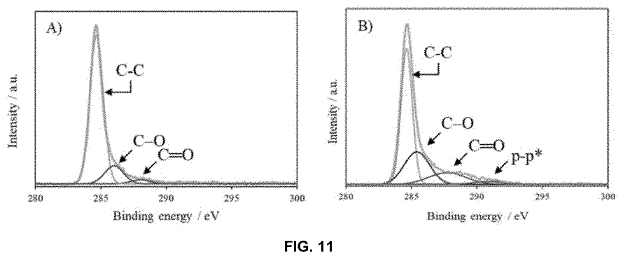

The modification of surface chemistry and elemental composition of AC following electrochemical regeneration cycles was analyzed by XPS (FIG. 11). In particular, the presence of oxygen functional groups in the surface of carbonaceous materials—well known to affect both phenol adsorption (Mattson, J. et al., J. Colloid Interface Sci. 1969, 31, 116-130) and oxygen reduction reaction (Garcia-Rodriguez, O. et al., Electrochim. Acta 2018, 276, 12-20)—was assessed through the deconvolution of the carbon peak at 284.5 eV. The existing oxygen functional groups on the surface of the original AC comprised of C—C (sp² configuration), C—O and C═O (from carboxylic acids and carbonyl groups) at 284.5, 286.5, 287.9, respectively (Mousset, E. et al., Electrochim. Acta 2017, 258, 607-617; Reiche, S. et al., Carbon 2014, 77, 175-183; and Zielke, U. et al., Carbon 1996, 34, 983-998). Following regeneration, AC-2h displayed a new peak at 291.1 eV, corresponding to p-p* aromatic rings transitions (Puziy, A. M. et al., Carbon 2008, 46, 2113-2123). The peak intensity of the oxygen-containing functional groups increased after the regeneration process. Moreover, the oxygen to carbon atomic ratio went up from 0.13 to 0.28. These changes could improve the adsorption of phenol (Tao, J. et al., Environ. Technol. 2019, 40, 171-181) due to the formation of donor-acceptor complexes between oxygen groups (donor) and phenol (electron acceptor), with oxygen from carbonyl groups having the highest affinity towards phenol (Moreno-Castilla, C. Carbon 2004, 42, 83-94).

1. A wastewater treatment reactor for use in electrochemical advanced oxidation processes, the reactor comprising:
a cathode;
an anode; and
a separator situated between the cathode and anode, wherein
the cathode comprises:
one or more fixed bed compartments, each of which has an inlet and an outlet for the passage of a wastewater;
a carbon brush situated in each of the one or more fixed bed compartments; and
activated carbon situated in each of the one or more fixed bed compartments,
where each carbon brush and activated carbon situated in each of the one or more fixed bed compartments are arranged within the compartment to contact a wastewater passing from the inlet to the outlet;
provided that, when there are two or more fixed bed compartments, the fixed bed compartments are arranged to operate in parallel to one another and not in series.

2. The reactor according to claim 1, wherein each of the one or more fixed bed compartments has a height/diameter ratio of from 8 to 12.

3. The reactor according to claim 1, wherein the activated carbon is provided in the form of granules.

4. The reactor according to claim 1, wherein the activated carbon is provided in an amount of from 0.05 to 5 g per cubic centimetre of volume in each of the one or more fixed bed compartments.

5. The reactor according to claim 1, wherein the separator fixes the carbon brushes and activated carbon in the one or more fixed bed compartments.

6. The reactor according to claim 1, wherein the separator comprises a frame and a carbon cloth or a metal mesh disposed within the frame, such that the carbon cloth or the metal mesh contacts the cathode and anode.

7. The reactor according to claim 1, wherein the anode is formed of boron doped diamond.

8. The reactor according to claim 1, wherein each of the one or more fixed bed compartments of the cathode has a height of 20 cm, a width of 2.5 cm and a depth of 1 cm.

9. The reactor according to claim 1, wherein the one or more fixed bed compartments of the cathode are three fixed bed compartments.

10. The reactor according to claim 1, wherein the reactor comprises part of a wastewater treatment apparatus, the apparatus further comprising a wastewater source in fluid communication with each inlet of the one or more fixed bed compartments of the cathode, a power supply connected to the cathode and anode and a treated water receptacle in fluid communication with each outlet of the one or more fixed bed compartments of the cathode.

11. A method of wastewater treatment comprising the steps of:
(a) a decontamination stage, where a wastewater comprising at least one contaminant is continuously supplied to a wastewater treatment apparatus as described in claim 10, comprising a reactor as required by claim 10, such that the wastewater enters through an inlet of one of the one or more fixed bed compartments of the cathode and is subjected to an electrochemical advanced oxidation process to remove the contaminant, such that the water passing through an outlet of the one or more fixed bed compartments of the cathode is a decontaminated water that has substantially none of the at least one contaminant present;
(b) a regeneration step, where the decontamination process of step (a) is stopped when a breakthrough amount of the at least one contaminant is detected and the reactor as required by claim 10 is then placed into an electrochemical regeneration cycle; and
(c) repeating steps (a) and (b).

12. The method according to claim 11, wherein the flow rate of the wastewater continuously supplied to the wastewater treatment apparatus is from 5 to 40 mL/min, such as from 8 to 14 ml/min.

13. The method according to claim 11, wherein the current applied in the electrochemical advanced oxidation process is from 1 to 30 mA/g.

14. The method according to claim 11, wherein the electrochemical advanced oxidation process is an electro-Fenton process.

15. The method according to claim 11, wherein the electrochemical regeneration cycle of the regeneration step is conducted for a period of from 10 to 180 minutes.

16. The method according to claim 15, wherein the electrochemical regeneration cycle of the regeneration step is conducted on activated that has reached from 18 to 50% of its theoretical loading capacity.

17. The method according to claim 1, wherein steps (a) and (b) can be conducted from 10 to 10,000 times.
